(19) United States
(12) Patent Application Publication
(10) Pub. No.: US 2003/0182314 A1
(43) Pub. Date: Sep. 25, 2003

(54) Method for inputting internet addresses

(76) Inventors: Shih-Kuang Su, Hsinchu (TW); Dai-Shui Ho, Taipei Hsien (TW); Pei-Zhi Li, Shanghai (CN)

Correspondence Address: BIRCH STEWART KOLASCH & BIRCH, PO BOX 747, FALLS CHURCH, VA, 22040-0747, US

(21) Appl. No.: 10/102,842

(22) Filed: Mar. 22, 2002

(51) Int. Cl. G06F 17/30

(52) U.S. Cl. 707/200

(57) ABSTRACT

A method for inputting internet addresses for use on a electronic communication device having an a display screen and a keyboard. A database storing internet address information is established. An input-message inputted with a CCITT-compliant keyboard is received. According to the input-message, alphabetic strings of internet addresses are read out from the database and displayed. A select signal inputted with the CCITT-compliant keyboard is received, to select one of the alphabetic strings. The selected alphabetic string is inputted to an edit field on the display screen. Thus, the internet address information can be rapidly inputted.

### BACKGROUND OF THE INVENTION

1. Field of the Invention

The present invention relates to a method for inputting characters, and more particularly, to a method for inputting internet addresses with a CCITT-compliant (Consultative Committee in International Telegraphy and Telephony) keyboard.

2. Description of the Prior Art

In this information age, portable electronic communication devices, such as mobile phones and PDAs (Personal Digital Assistant), are very popular. Since the size of the communication devices is very small, a CCITT-compliant keyboard having only 12 keys is usually used. FIG. 1 is a front view of a mobile-phone handset that utilizes a CCITT-compliant keyboard. The mobile phone handset further includes a pair of control keys (key OK & key NO); a shift key (up, down, left and right); and a display screen (such as LCD). The functions of the control keys and shift key are well-known, so detailed description thereof will not be given in this specification. The CCITT-compliant keyboard includes 12 physical keys: key 1, key 2, key 3, key 4, key 5, key 6, key 7, key 8, key 9, key *, key 0 and key #. The user can use these keys to input both numbers and English letters to the mobile-phone handset which can then transmit the input message through a radio link to the receiving side.

The conventional method for internet address input with the CCITT-compliant keyboard is very laborious and time-consuming. For example, the steps for inputting a long internet address “www.chinatimes.com.tw/index.html” with the CCITT-compliant keyboard are: pressing key 9 one time so as to input “w”, pressing key 9 one time so as to input “w”, pressing key 9 one time so as to input “w”, pressing the symbol key so as to input “.”, pressing key 2 three times so as to input “c”, pressing key 4 two times so as to input “h”, pressing key 4 three times for inputting “i”, press key 6 two times so as to input “n”, press key 2 one time so as to input “a”, press key 8 one time so as to input “t”, press key 4 three times so as to input “i”, press key 6 one time so as to input “m”, press key 3 two times so as to input “e”, pressing key 7 four times so as to input “s”, and so on.

To find solutions to the above-mentioned drawbacks of the prior art, a research effort is underway in the industry to develop an easy-to-use input method for internet addresses that allows the user to perform the task of internet address input to the portable electronic communication device more conveniently and efficiently with a CCITT-compliant keyboard.

### SUMMARY OF THE INVENTION

The object of the present invention is to provide a method for inputting internet addresses with a CCITT-compliant keyboard.

Another object the present invention is to provide a method that allows internet address information to be added, deleted and edited, and then to be stored in the database.

To achieve the above-mentioned object, the present invention provides a method for inputting internet addresses for use on an electronic communication device having a display screen and a keyboard. A database storing internet address information is established. An input-message inputted with a keyboard is received. According to the input-message, alphabetic strings of internet addresses are read out from the database and displayed. A select signal inputted with the keyboard is received, to select one of the alphabetic strings. The selected alphabetic string is inputted to the edit field on the display screen.

Moreover, the selected alphabetic string is edited to get an edited alphabetic string. The edited alphabetic string may be stored in the database. In addition, the selected alphabetic string can also be deleted from the database.

### BRIEF DESCRIPTION OF THE DRAWINGS

The present invention can be more fully understood by reading the subsequent detailed description in conjunction with the examples and references made of the accompanying drawings, wherein:

FIG. 1 is a front view of a mobile-phone handset that utilizes a CCITT-compliant keyboard.

FIG. 2 is a schematic block diagram showing the system architecture of the first embodiment of the present invention when implemented through software.

FIGS. 3a˜3f are diagrams showing process steps according to the second embodiment of the present invention for inputting internet address to the mobile-phone handset.

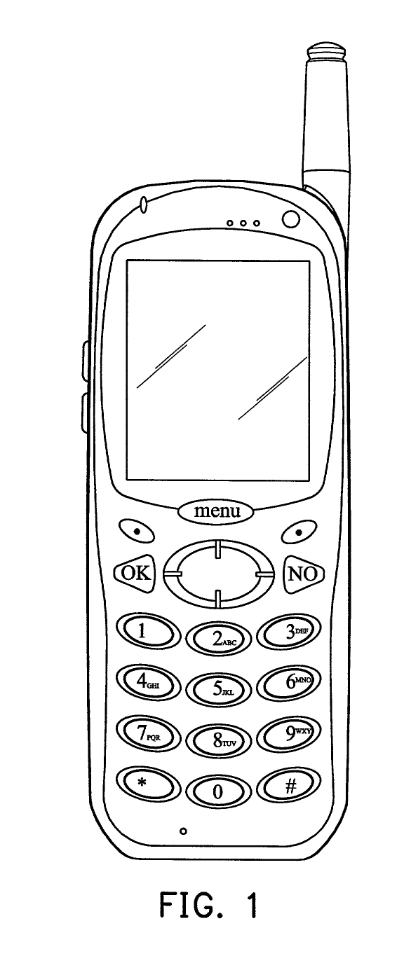

### DETAILED DESCRIPTION OF THE INVENTION

The First Embodiment

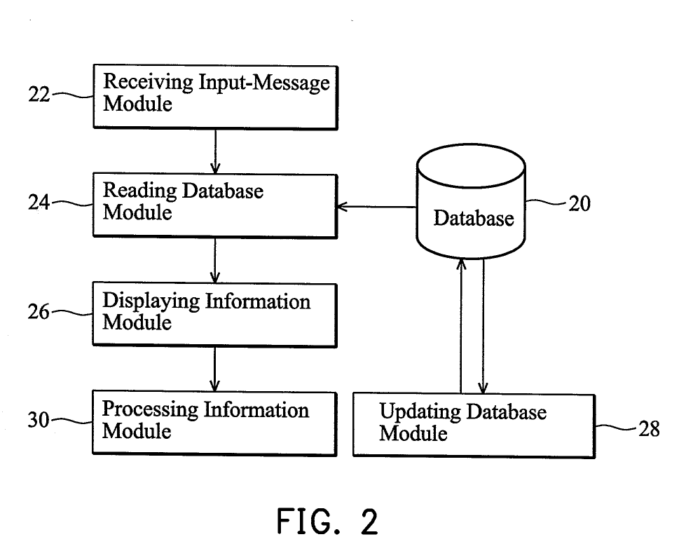

FIG. 2 is a schematic block diagram showing the system architecture of the first embodiment of the present invention when implemented through software. As shown, the software architecture implementing the first embodiment of the present invention includes a database 20, a receiving input-message module 22, a reading database module 24, a displaying information module 26, a updating database module 28 and a processing information module 30.

The database 20 is used to store internet address information. The receiving input-message module 22 is used to receive a message inputted with a keyboard. The message is used to activate the internet address input function. The reading database module 24 is used to read out internet address information from the database 20 according to the message. The displaying information module 26 is used to display the internet address information read out from the database 20 on a display screen. The processing information module 30 is used to process the displayed internet address information. For example, an alphabetic string is selected and inputted to an edit field on the display screen by the processing information module 30. Moreover, the updating database module 28 may be used to add, delete or edit the internet address information and stored updated information in the database 20.

The internet address information preferably comprises protocol information, organization information and area information. For instance, the protocol information may be the alphabetic strings “www”, “wap” or “ftp”; the organization information may be the alphabetic strings “com”, “net”, “edu” or “org”; the area information may be the alphabetic strings “cn”, “tw”, “hk”, “sg” or “jp”; wherein the English letters can be capital letters. These alphabetic strings can be stored in the database 20 in advance for the convenience of use.

Moreover, some specific symbols, such as “.”, “,”, “;”, “:”, “-”, “_”, “(”, “)”, “?”, etc., are used in internet addresses. These specific symbols can be added to the database 20 by the updating database module 28. Thus, the intended symbol or intended alphabetic string can be input once and then stored in the database 20. When the symbol or alphabetic string is needed next time, the symbol or alphabetic string can be conveniently selected from the database 20.

The Second Embodiment

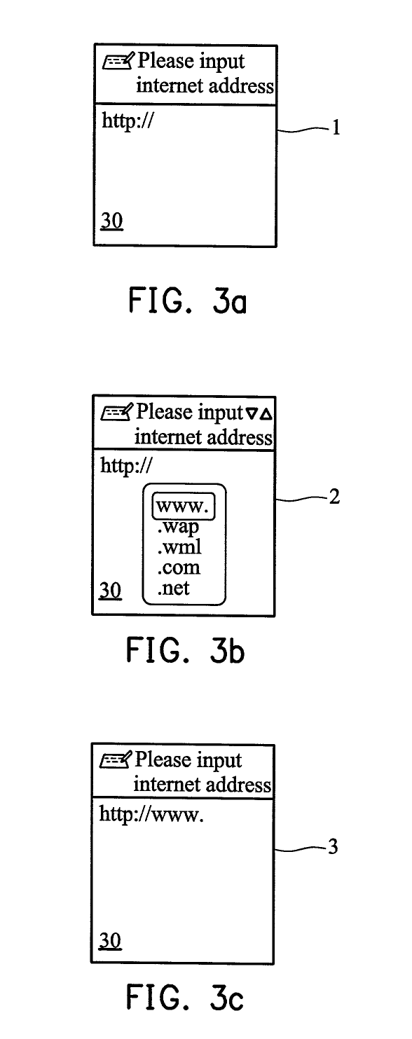

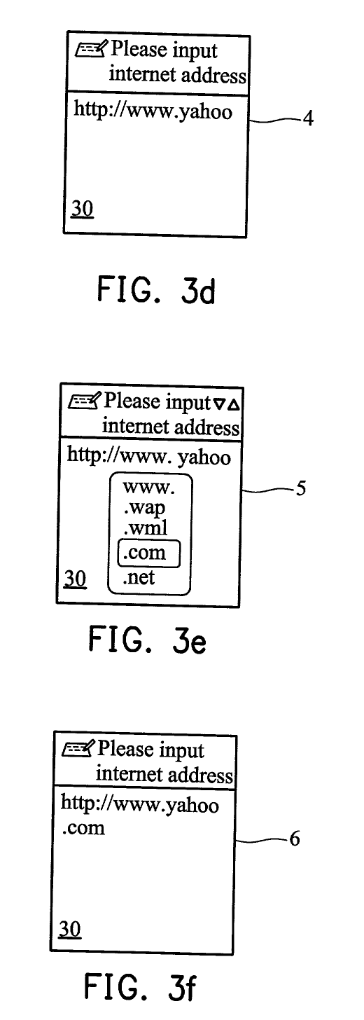

FIG. 3a˜3f are diagrams showing process steps according to the second embodiment of the present invention for inputting internet address to a mobile-phone handset, wherein the mobile-phone handset has an edit field 30 shown on a display screen, a keyboard and a database. As a demonstrative example, when an internet address, such as www.yahoo.com, is inputted with a CCITT-compliant keyboard, the steps are as follows.

In FIG. 3a, the internet address input function is activated in response to user request, as shown as the display screen 1.

In FIG. 3b, alphabetic strings of internet addresses are read out from the database which stores internet address information and are displayed, as shown as the display screen 2.

In FIG. 3c, the alphabetic string “www.” is selected and inputted to the edit field 30 on the display screen, as shown as the display screen 3.

In FIG. 3d, the alphabetic string “yahoo” is inputted to the edit field 30 on the display screen with the CCITT-compliant keyboard, as shown as the display screen 4. The steps for inputting the alphabetic string “yahoo” with the CCITT-compliant keyboard are: pressing the key 9 three times so as to input “y”, pressing the key 2 one time so as to input “a”, pressing key 4 two times so as to input “h”, pressing key 6 three times so as to input “o”, and pressing key 6 three times so as to input “o”.

In FIG. 3e, the alphabetic strings of internet addresses are read out from the database and displayed, as shown as the display screen 5.

In FIG. 3f, the alphabetic string “.com” is selected and inputted to the edit field 30 on the display screen, as shown as the display screen 6. Thus, the input of internet address “www.yahoo.com” is accomplished.

Moreover, if the alphabetic string “yahoo” is often used, the function of the updating database module 28 in the first embodiment can be used to add the alphabetic string “yahoo” to the database. When the alphabetic string “yahoo” is needed next time, the alphabetic string “yahoo” can be conveniently selected from the database. Thus, according to the method of the present invention, the user can perform the task of a long internet address input to the electronic communication device more conveniently and efficiently than in the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for inputting internet addresses for use on an electronic communication device having a display screen and a keyboard, comprising the steps of:
establishing a database, which stores internet address information;
receiving an input message inputted with the keyboard;
according to the input message, reading out and displaying alphabetic strings of internet addresses from the database;
receiving a select signal inputted with the keyboard, to select one of the alphabetic strings; and
inputting the selected alphabetic string to an edit field on the display screen.

2. The method as claimed in claim 1, further comprising the step of:
editing the selected alphabetic string to get an edited alphabetic string.

3. The method as claimed in claim 2, further comprising the step of:
storing the edited alphabetic string in the database.

4. The method as claimed in claim 1, further comprising the step of:
deleting the selected alphabetic string from the database.

5. The method as claimed in claim 1, wherein the database comprises at least one type of information selected from the group consists of protocol information, organization information and area information.

6. The method as claimed in claim 5, wherein the protocol information comprises the alphabetic strings “www”, “wap” and “ftp”.

7. The method as claimed in claim 5, wherein the organization information comprises the alphabetic strings “com”, “net”, “edu” and “org”.

8. The method as claimed in claim 5, wherein the area information comprises the alphabetic strings “cn”, “tw”, “hk”, “jp” and “sg”.

9. The method as claimed in claim 1, wherein the keyboard is a CCITT-compliant keyboard.
